(19) United States
(12) Patent Application Publication
(10) Pub. No.: US 2007/0232397 A1
(43) Pub. Date: Oct. 4, 2007

(54) Remote slot machine controller

(76) Inventor: Arnon Katz, London (GB)

Correspondence Address: Martin D. Moynihan;PRTSI, Inc., P.O. Box 16446, Arlington, VA, 22215, US

(21) Appl. No.: 11/395,168

(22) Filed: Apr. 3, 2006

(51) Int. Cl. A63F 13/00

(52) U.S. Cl. 463/42

(57) ABSTRACT

A remote slot machine controller for facilitating the participation of remote users in a slot machine game sequence, the remote slot machine controller comprising: a physical input device configured to allow a user to input game instructions during a slot machine game sequence, a user input payment device adapted to allow a user to input payment information, and a communication interface connectable to a wagering server system via at least one communication network, the communication interface adapted to transmit the payment information and the game instructions to the wagering server system.

### FIELD AND BACKGROUND OF THE INVENTION

The present invention relates to slot machines and, more particularly but not exclusively, to interactive slot machine apparatus and to a distributed slot machine system.

Originally, casinos installed slot machines as a diversion for casual gamblers. Unlike traditional table games (such as blackjack or roulette), slot machines don't require any gambling knowledge, and anyone can get in the game with a very small bet.

This idea proved to be a success, and slot machines eventually moved off the sidelines to become the most popular and the most profitable game in town, bringing in more than 60 percent of the annual gambling profits in the United States.

The technology of slot machines has also changed a lot over the years. The classic mechanical designs have been almost completely replaced by computer-controlled machines. But the game has remained the same. The player pulls a handle to rotate a series of reels that have pictures printed on them. Winning or losing is determined by which pictures line up with the pay line, a line in the middle of a viewing window. If each reel shows the same winning picture along the pay line, the player wins (certain single images are sometimes winners as well). The amount won depends on which pictures land along the pay line and, sometimes, their order.

The classic slot machine design works on an elaborate configuration of gears and levers. The central element is a metal shaft, which supports the reels. This shaft is connected to a handle mechanism that actuates the machine. A braking system brings the spinning reels to a stop, and sensors communicate the position of the reels to the payout system. A coin detector initially registers that a coin has been inserted and unlocks a brake so the handle can move.

The player inserts a coin or a credit card and pulls the handle. There is a clunk, and at least three reels start spinning. Then the reels stop abruptly, one at a time, followed either by a payout and resetting of the machine, if the player wins, or by resetting of the machine if the player doesn't win. Usually, the reels stop one at a time, so as to build suspense for the player. If the first reel stops on the jackpot symbol, then the player has to wait for the next reel to stop to see if it is a jackpot, and then he has to wait for the last reel to stop. If all reels display the same symbol, the player wins.

Conventional mechanical slot machines eventually gave rise to electrical machines that worked on similar principles. In an electrical machine, the reels are spun by motors and the stoppers are generally activated by solenoids, but the game is basically played the same way. Electrical machines have more sophisticated money-handling systems that facilitate the use of credit cards or other methods of payment and have flashier light and sound displays.

Recently made slot machines are designed to look and feel like the old mechanical models, but they work on a completely different principle. The outcome of each pull is actually controlled by a central computer inside the machine, not by the motion of the reels.

The computer uses step motors to turn each reel and to stop it at a predetermined point. Step motors are driven by short digital pulses of electricity controlled by the computer, rather than by the fluctuating electrical current that drives an ordinary electric motor.

Usually, a random number generator at the heart of the computer ensures that each pull has equal winning chances.

Whenever the slot machine is turned on, the random number generator generates whole numbers, typically between 1 and several billions, hundreds of times a second. The instant the user pulls the handle or presses the button, the computer records the next few numbers from the random number generator. Then it feeds these numbers through a simple program to determine where the reels should stop.

One of the main advantages of the computer system is that it enables machine manufacturers to easily configure how often the machine pays out.

Various types of slot machine apparatuses that even combine a video display are known. An example is disclosed in U.S. Pat. No. 6,811,482, issued on Nov. 2, 2004. In this patent application there is disclosed a gambling apparatus that bridges the entertainment gap that currently exists between skill-based video game entertainment and the traditional formats of video games of chance. U.S. Pat. No. 6,811,482 provides a three dimensional software “world” as the gambling environment and, through the incorporation of human interface devices, provides the player with the feeling of control experienced when playing a skill-based video game, while maintaining the random outcome requirements of standard video games of chance.

The U.S. Pat. No. 6,811,482 slot machine is, however, an industrial slot machine that is designated for casino houses and businesses.

Hence, in order to use such slot machines, individuals are still required to travel to an establishment where these electronic machines are located.

In addition, with the advent of the Internet, network based slot machines and wagering server systems were integrated into the gambling industry. Such a technological advancement is described in U.S. Pat. No. 6,361,437, issued on Mar. 26, 2002. This patent application discloses a method and system for remote play of a gambling device, such as a slot machine. A player enters play preferences at a remote wagering terminal. The remote wagering terminal transmits the play preferences to a slot network server that stores the play preferences. Based upon the play preferences, the slot network server identifies one or more slot machines and transmits outcome data from those slot machines to the remote wagering terminal. The slot network server keeps track of the player's winnings and losses based upon the outcome data.

Thus, such an invention facilitates the establishment of a conventional slot machine network at different wagering sites.

Recent developments allow home users to participate in gambling games from their own personal computer via the Internet or World Wide Web. The individual merely has to use a personal computer to connect to the Internet through a computer having a modem, or through another means of access to the Internet, log on to a gambling website, and participate in a wide variety of gambling activities that are offered online. The participating individuals employ credit card or similar credit accounts as a source of funds for these gambling activities.

Such a gambling website displays a graphical user interface (GUI) that facilitates the virtual pulling of the displayed handle. The website provides the clunk sound of the traditional slot machine, and displays the spinning reels.

The website further facilitates the inputting of method of payment and the amount the user is willing to risk. A common mouse device and a common laptop or desktop keyboard, both connected to the computing unit, can allow users to input the needed information and to control and maneuver the virtual handle.

Such websites do not, however, give the users the feeling of pulling a real slot machine handle.

In addition, the access to such websites is limited to Internet users.

Moreover, there are users that do not feel comfortable with the Internet for reasons such as lack of knowledge in operating computers or fear of using electronic payment over unsecured networks.

Thus, there is a widely recognized need, not satisfied by the prior art, for a remote slot machine or slot machine controller devoid of the above limitations.

### SUMMARY OF THE INVENTION

According to one aspect of the present invention there is provided a remote slot machine controller apparatus for facilitating the participation of a remote user in a slot machine game sequence. The remote slot machine controller apparatus comprising: a physical input device configured to allow a user to enter a game input during a slot machine game sequence, and a communication interface connectable to a wagering server system via at least one communication network, the communication interface being adapted to transmit the payment information and the game input to the wagering server system.

Preferably the remote slot machine controller apparatus further comprising a user input payment device adapted to facilitate users with the ability to input payment information.

More preferably the payment information consists of at least one of the following group members: personal identification information, a password, a preferred payment method, payment method information, credit card number and expiration date, identification password and the amount of the wager, bank account number.

Preferably the physical input device comprises a handle, pivotally mounted on housing.

Preferably the remote slot machine controller apparatus further including a housing, wherein the physical input device is a button coupled to the housing.

More preferably the remote slot machine controller apparatus is coupled to a fixation component, the fixation component being adapted for attaching the physical input device to a solid surface.

Preferably the communication interface is adapted to interface with one of the following communication devices: a mobile phone, a cable modem, a satellite receiver, a personal computer, a personal digital assistant (PDA) and a land line telephone.

More preferably the communication interface comprises an infrared radiation (IR) transmitter, and wherein the communication interface is adapted to interface with a communication device that comprises an IR receiver.

According to another aspect of the present invention there is provided a distributed slot machine system for facilitating the participation of remote users in a slot machine game sequence. The distributed slot machine system comprising: at least one display device being adapted for generating video images of a slot machine and at least one remote slot machine controller associated with the display device. The remote slot machine controller comprising: a physical input device configured to allow a user to provide a slot machine game instructions input, a user input payment device adapted to facilitate users with the ability to input payment information, and a communication interface connectable to a wagering server system via at least one communication network, the communication interface being adapted to transmit the payment information and the game instructions input to the wagering server system. The wagering server system is adapted for receiving the payment information and the game instructions input from the at least one remote slot machine controller, wherein the wagering server system is adapted for performing the game sequence based on the game instructions input, transmitting a game result based on a result of the game sequence and a payment made, to the display device, and wherein the wagering server system comprises a payment module for either debiting or crediting the account of a player according to the game result.

According to another aspect of the present invention there is provided a

According to another aspect of the present invention there is provided a method of participating in a slot machine game sequence, comprising: a) providing a remote slot machine controller comprising: a physical input device, a user input payment device, and a communication interface, b) providing a display device being adapted to generate video images of a virtual slot machine, c) connecting the communication interface to a wagering server system via at least one communication network, d) using the user input payment device to input payment information and associating the payment information with a player account, e) transmitting the payment information to the wagering server system, f) using the physical input device to input game instructions for initiating a slot machine game sequence, g) using the wagering server system to simulate the slot machine game sequence, h) using the display device for displaying the outcome of the slot machine game sequence, and i) updating the player account according to an outcome of the slot machine game sequence.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a perspective view of an exemplary, remote slot machine controller with a handle, according to an embodiment of the present invention;

FIG. 2 is a perspective view of an exemplary, remote slot machine controller with a spinning button, according to another embodiment of the present invention;

FIG. 3 is a view of an exemplary, remote slot machine controller connected to a wagering server system via a cable modem, according to a preferred embodiment of the present invention;

FIG. 4 is a view of another exemplary, remote slot machine controller connected to a wagering server system via a computer network, according to a preferred embodiment of the present invention;

FIG. 5 is a view of another exemplary, remote slot machine controller connected to a wagering server system via a cellular network, according to a preferred embodiment of the present invention;

FIG. 6 is a view of an exemplary, distributed gambling system for facilitating the participation of remote users in slot machine gambling sequences, according to a preferred embodiment of the present invention; and

FIG. 7 is a simplified flowchart diagram of a method for participating in a slot machine gambling sequence, according to a preferred embodiment of the present invention.

### DESCRIPTION OF THE PREFERRED EMBODIMENTS

The present embodiments comprise an apparatus, a system and a method for a distributed remote slot machine controller.

The principles and operation of an apparatus and method according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

The present embodiments relate to a remote slot machine controller apparatus, a distributed system of a remote slot machine controller and a method of using such a remote slot machine controller to participate in a slot machine gambling sequence.

The remote slot machine controller is designed to have the look of a conventional slot machine user interface and to give a player the feeling of interfacing with such. The look refers to design aspects in terms of both colors and shape, and the feel refers to the behavior of dynamic elements such as buttons, handles, etc.

The remote slot machine controller is designed to simulate the feeling of participating in a gambling sequence using a conventional slot machine. Pulling the handle or pressing a designated spinning button of the remote slot machine controller provides the user with realistic tactile feedback that mimics the feel of pulling an actual slot machine handle or pressing a conventional slot machine spinning button.

In addition, unlike conventional slot machines which are usually located in public locations, the remote slot machine controller allows the player to gamble from private remote locations such as, inter alia, private homes or private hotel rooms.

Indeed, known gambling websites facilitate the participation of users in virtual slot machine gambling sequences. This participation is done via the personal computer or other devices that facilitate access to the Internet. The player gives gambling instructions via a common mouse device or a common desktop keyboard.

However, access to the gambling websites is limited to Internet users.

Moreover, when a player participates in a slot machine gambling sequence via the aforementioned websites, the external look of a slot machine is clearly lacking and the player does not get the feeling of playing on a conventional slot machine.

As will be elaborated below, the remote slot machine controller according to the present embodiments enables users to perform gambling sequences using different communication devices, like interactive television or mobile phones which are considered as more user friendly than the Internet for some people.

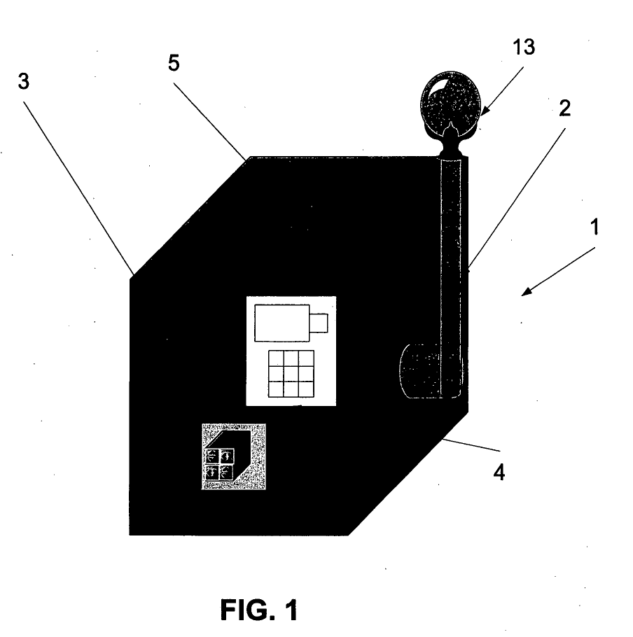

Reference is now made to FIG. 1 which depicts an exemplary remote slot machine controller 1 for facilitating the participation of a remote player in a slot machine gambling sequence according to one embodiment of the present invention. FIG. 1 is a perspective view showing the external appearance of the remote slot machine controller 1. The remote slot machine controller 1 comprises a physical input device or Handle 2, a user input payment device 4 and a communication interface 3.

The remote slot machine controller 1 is designed to allow players to input gambling instructions during a slot machine gambling sequence.

With respect to playing the slot machine, preferably, the physical input device 2 operates as a user interface, allowing players to initiate a slot machine gambling sequence in a conventional manner.

In the depicted preferred embodiment of FIG. 1, the input device is a handle 2 disposed alongside a housing 5.

In the conventional mechanical slot machine (not shown), when a player pulls the handle, he causes a shaft, which supports the reels that have pictures printed on them, to spin. The pulling of the shaft initiates the spinning of the reels which stop spinning one at a time. Then, one picture from each reel is lined up with the pay line, a line in the middle of a viewing window that displays the final outcome of the gambling sequence.

Pulling the handle 2 of the remote slot machine controller 1 simulates the initiation instructions of a handle of a conventional mechanical slot machine.

Accordingly, the handle is preferably a tubular lever, and a typical length would be 20 to 30 cm.

Hence, pulling the handle 2 leads to the transmission of initiation instructions via the communication interface 3 to a wagering server system (not shown) that simulates the gambling sequence of a conventional slot machine.

Preferably, the handle is resilient in that it tries to return to its initial position. Resilience may be achieved by connecting to a spring or like tensioning device. The spring or other tensioning is connected such as to increase tension as the lever is rotated by the user. The handle thus automatically reverts to its initial position after the user has released the handle.

The classic slot machine includes a grip at the end of the lever, and such a grip is preferably included in the present embodiments in order to give the look and feel of the classic slot machine. Thus, the top end of the handle is either enlarged or coupled to a hand grip 13. The enlarged portion of the handle or the hand grip 13 is designed to support the palm of the user during the pulling. The input device 2 allows players to initiate the rotation of a simulated series of reels that have pictures printed on them which will be presented on a conventional screen as will be described below.

In order to give the player the tactile feeling of pulling a handle of a conventional slot machine, in one preferred embodiment of the present invention the handle 2 may have a force feedback mechanism integrated therewith. The force feedback mechanism gives the player feedback as a type of force, during the player interaction with the handle 2. When the player pulls the handle 2 the force feedback mechanism provides a resistance to the force applied by the player. The force feedback resistance simulates the resistance of the shaft, gears and levers of the mechanical slot machine, which conventionally support the reels and apply force on the handle when in use.

In addition, in order to further improve the tactile feeling of pulling the handle 2, the remote slot machine controller 1 is preferably coupled to a fixation component (not shown) such as a rubber suction pad. The fixation component is used to firmly attach the remote slot machine controller 1 to a solid surface (not shown) such as a table or a chair. Since conventional slot machines are heavy machines which cannot be easily moved or rocked, the aforementioned firm attachment further facilitates the simulation of a conventional slot machine.

The fixation component optionally includes a middle connecting component for use between the fixation component and the remote slot machine controller 1.

Preferably, the middle connecting component enables rotation of the remote slot machine controller 1 to various angles. The middle connecting component is designed to allow the positioning of the remote slot machine controller 1 at a desired azimuth and elevation angle relative to the fixation component.

Preferably, the remote slot machine controller 1 further comprises one or more audio speakers (not shown) connected to a sound-generating circuit (not shown). The sound-generating circuit produces audio signals according to the user gambling instructions. For example, pulling the handle 2 may provide the audio speakers with various forms of sound relevant to pulling the handle of a conventional slot machine. In addition, the speakers can be used to produce casino background sounds.

Preferably, the remote slot machine controller 1 further comprises one or more light bulbs (not shown). The light bulbs may be flashed to provide the player with the feeling of a conventional slot machine.

The remote slot machine controller 1 may be connected to a power supply. The electrical current to the remote slot machine controller 1 can be either from an Alternating Current (AC) source or from a Direct Current (DC) source.

Preferably, the remote slot machine controller 1 further comprises a battery housing (not shown) for supplying DC electric current. The battery housing can house either rechargeable batteries or regular batteries.

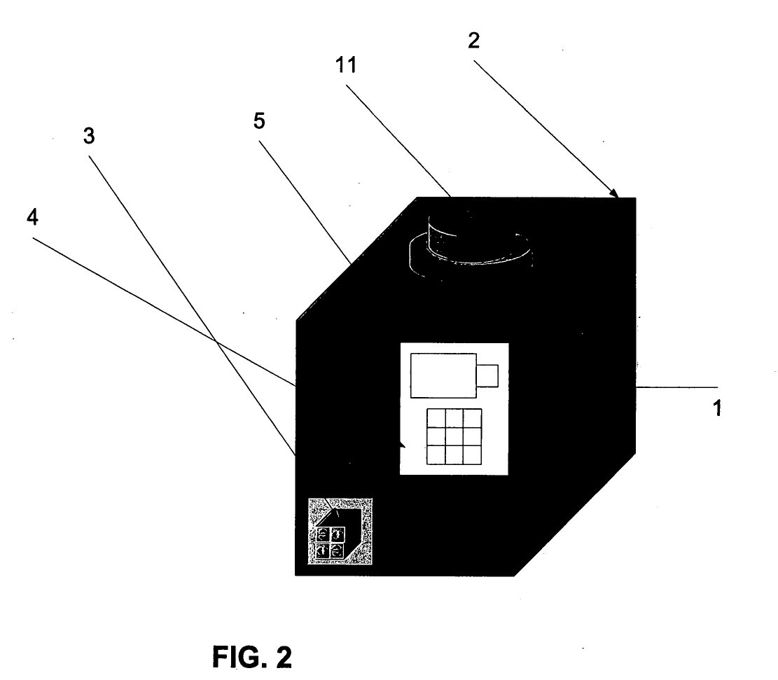

FIG. 2 is a perspective view of a remote slot machine controller 1 that comprises a spinning button 11 instead of a handle, as in FIG. 1, according to another preferred embodiment of the present invention. In this embodiment the same instructions are sent via the communication interface 3 after the player pushes a designated spinning button 11 which is coupled to the housing 5. This embodiment facilitates the simulation of a slot machine that does not comprise a handle.

In the remote slot machine controller 1, the communication interface 3 is the key element in the present invention that allows the connection of the remote slot machine controller to designated communication devices (not shown). The communication interface is connectable to a remotely located wagering server system (not shown) via one or more communication networks (not shown). This facilitates the transmission of, Inter alia, gambling instructions to a wagering server system (not shown).

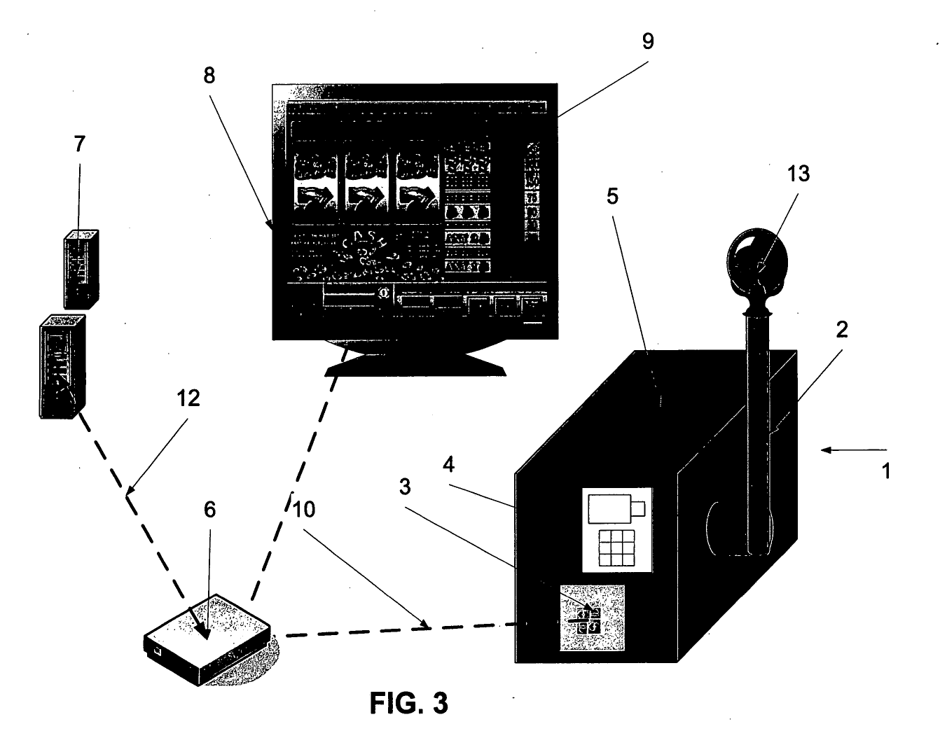

Reference is now made to FIG. 3 which shows another exemplary embodiment of the present invention. The slot machine gambling controller 1 is similar to that shown in FIG. 1 above. However this figure further depicts a wagering server system 7 and a display screen 8.

As further depicted in this embodiment, the communication interface 3 of the remote slot machine controller 1 is connected, via a communication link 10, to a cable modem 6. The cable modem 6 is further connected to wagering server system 7 via a two-way connection 12. In addition, the cable modem 6 is connected to display screen 8 in a conventional manner.

Since cable connection 12 is a two-way connection, it facilitates the transmission from a broadcaster's Headend or central office to the viewer's location and then back to the Headend or central office.

The remote slot machine controller 1 is connected to the cable modem 6, and transmits the player's gambling instructions from a remote location to the wagering server system 7 over the cable pipe backchannel of the cable network.

Preferably, the communication interface 3 of the remote slot machine controller 1 is an IR transmitter. The IR transmitter is operable to establish a communication connection with a conventional IR receiver (not shown). Such IR receivers are commonly integrated into conventional cable modems and are used as receivers for instructions from a conventional remote control.

Preferably, the communication receiver is a satellite TV receiver (not shown). In this preferred embodiment, the transmission from the wagering server system 7 to the remote slot machine controller 1 is done via a transponder on a satellite that transmits, in a downlink stream, designated signals to the player's satellite TV receiver (not shown).

Conditional Access Technologies are one example of Technologies which are embedded on the satellite receiver that enables the satellite broadcaster to provide players with designated signals to the remote slot machine controller.

However, the transmission from the remote slot machine controller to the wagering server system cannot be done via the satellite since the uplink connection is expensive and demands a designated transponder. Hence, the transmission to the wagering server system 7 is done through the backchannel of the satellite TV receiver (for example over a phone wire).

In order to provide the player with a visual image of the slot machine and of the gambling sequence, the content supplier of the virtual slot machine gambling system preferably establishes a separate communication session with each player.

A separate connection is needed to reflect the player actions and instructions. Moreover, it is desirable that the player receives an immediate response to his instructions or request in order to give the player the feeling of using a conventional slot machine.

In one preferred embodiment, a content supplier designates a Digital Video Server for allowing remotely located players to receive immediate visual feedback to the gambling instructions they transmit using the remote slot machine controller.

Preferably, the content supplier designates a robust, dedicated Digital Video Server at a central location that receives a command request from the wagering server system. The command request is sent relative to gambling instructions that a player has sent using his remotely located remote slot machine controller.

Once the designated server receives the request, it instantly broadcasts a specific digital video stream of a visual image of a simulated slot machine to a remotely located communication device of a specific player. The visual image simulates operation of a conventional slot machine in response to the player's actions, according to the operation of the remote slot machine controller. For example, the Digital Video Server simulates the initiation of a gambling sequence by broadcasting a specific digital video stream of a visual image of spinning reels. As elaborated below, the outcome of the gambling sequence is also displayed by a screen display.

SeaChange, nCUBE, and Concurrent are examples of companies that provide this kind of equipment and software services for creating such an infrastructure.

The visual display or image 9 of the simulated slot machine is displayed on a screen display 8 which is connected to the communication device (not shown) that interfaces which the wagering server system 7.

Preferably, the visual image 9 is created by slot machine software that comprises a graphic engine. The slot machine software is, preferably, hosted on the Digital Video Server which is part of the wagering server system.

The graphic engine is an integral part of the slot machine software program, and is utilized to generate a virtual video display of the slot machine, focusing on the slot machine reels and pay line, a line in the middle of a viewing window that crosses through the spinning reels. There are numerous graphic engines which are capable of generating the virtual display of a slot machine, such as those of Truevision, Quake, etc., which are well known in prior art.

The slot machine software program runs on a hosting server microprocessor. The slot machine software program is configured to create a computer graphic surface forming either two-dimensional or three-dimensional virtual reels having pictures thereon.

The virtual reels are presented to a player on the screen display 8. The screen display may be a video monitor, a television, or any other electronic or mechanical instrument capable of displaying graphic images which are received from the wagering server system 7.

Preferably, the slot machine software program may also comprise an additional feature to enhance a player's game-playing experience, such as a sound module. Accordingly, the slot machine software program generates audio signals which are transferred to the relevant sound module.

Preferably, the remote slot machine controller 1 further comprises one or more audio speakers (not shown) connected to a sound-generating circuit. The sound-generating circuit receives the audio signals and provides the audio speakers with various forms of sound relevant to a slot machine game and a casino environment.

For example, the speakers may generate audio signals that represent sounds of spinning reels, casino background music, announcements or any other suitable audio signals related to a conventional slot machine game.

The slot machine software program further comprises a gambling module. The gambling module is designed to simulate a slot machine gambling sequence and to calculate accordingly the final position of the virtual spinning reels, determining the gambling outcome, and thereby the payment outcome.

As described above, the user uses the remote slot machine controller 1 to transmit gambling instructions to the wagering server system 7. Subsequent to the reception of the initiation of instructions by the wagering server system 7, the gambling module which is hosted by one of the wagering server system's servers, generates a random number.

The hosting server's processor looks up the generated random number in a stored probability table and finds the corresponding outcome in the probability table that reflects a different combination of spinning reel symbols in different final orientations of the reels.

The distribution in the probability table reflects the probability of each combination of the spinning reel symbols appearing in the pay-line of a corresponding conventional slot machine.

Based upon the identified outcome, the hosting server updates the player's credit balance.

If the outcome of the virtual reels indicates that the player has won the gambling sequence, the hosting server processor locates the appropriate payout in a stored payout table and updates the player's credit balance in a designated database server of the wagering server system, as described below.

If the outcome of the virtual reels indicates that the player has lost the gambling sequence, the hosting server processor credit the player's credit balance in the designated database server of the wagering server system, as described below.

In addition, the gambling module outputs the combination of spinning reel symbols to the graphic module. The graphic module produces a visual image that corresponds to the combination, as described above.

For example, when the calculated final orientation of the reels reveals “bar-bar-dollar” the gambling module may have determined that, according to the payout table, the player should receive a payout of ten dollars. The gambling module then communicates with the database server of the wagering server system to update the credit balance with a payout of ten dollars. In addition, the gambling module then further communicates with the graphic model that produces a visual image of spinning reels that spins until the combination “bar-bar-dollar” appears in the virtual line-up window.

Preferably, the slot machine software, using the graphic model, generates a visual image 9 that corresponds with the output combination of spinning reel symbols, as described above. The wagering server system 7 transmits signals that represent the aforementioned visual image 9 to the communication device 6. The communication device 6 displays the aforementioned combination of spinning reels symbols on display screen 8.

In order to simulate the look of a conventional slot machine, the visual image is a video display of spinning reels that periodically spin until the aforementioned combination of spinning reel symbols is lined up in the middle of a virtual viewing window. Each reel shows a symbol along the pay line that matches the predetermined combination. The amount the player wins or loses is correlated with the symbols which have landed along the pay line and, sometimes, with the order in which the symbols are presented.

Another key element of the remote slot machine controller is the user input payment device 4.

The remote slot machine controller 1 is located in a remote location. Hence, in order to enable players to have the ability to place a bet for gambling, a user input payment device 4 is needed.

The user input payment device 4 is a device that facilitates the input of payment information, such as personal identification information, for debiting and the like.

Preferably, the user input payment device 4 is a keypad consisting of a separate grid of numerical keys and function keys arranged for efficient data entry.

In one preferred embodiment of the present invention, the user input payment device 4 is a remote control (not shown) of a cable modem or other receiver. When a cable modem or the TV Satellite receiver is set to a designated channel, after a connection with the wagering server system has been established, the remote control can be used to input payment information. Preferably, the screen display which is connected to the cable modem or to the receiver can be used to display the received payment information.

Preferably, at the start of the gambling sequence, the player can input payment information such as credit card number and expiration date using the user input payment device 4.

In another preferred embodiment of the present invention the user input payment device 4 is used to enter a personal password which is uniquely identified which the player.

Preferably, the user input payment device 4 further comprises an assembly including an optical or a magnetic card reader unit. The assembly of the user input payment device and the card reader unit accepts a player's credit card, a player's hotel room key, a mechanical card, a setup card and self-diagnostic cards via a card aperture. Such an assembly is used to read in a conventional manner the identification symbols of each card and to use the identification information as payment information.

Preferably, a screen display may be provided to work in cooperation with the user input payment device. In this preferred embodiment the screen 8 displays the input digits or characters, allowing the user to check the validity of the input payment information. One example of a typical display is a two-line by 16 character liquid crystal display with backlighting.

The input payment information is transferred to the wagering server system 7 via the communication interface 3.

Preferably, the wagering server system, during the period immediately following the reception of the payment information by the player, performs security verification, with respect to the nature of the payment information. For example, if the payment information comprises a credit card, the wagering server system 7 verifies the credit card validity. If the payment information comprises a password, the wagering server system 7 verifies the suitability of the password. The security verifications are performed as a part of the gambling process, to minimize the possibility of fraud or misrepresentation.

Preferably, the wagering server system prevents a player that does not pass the security verification process from participating in a slot machine gambling sequence. This step is required to ensure that the player can place a bet.

Preferably, a unique account is assigned to new players which comply with the security verification process established. The account is stored in the memory of a designated database server of the wagering server system 7.

Preferably, the database server of the present embodiment includes multiple records having multiple fields of information related to player identification.

Specifically, the database server comprises multiple records, each record being associated with a particular player. Key fields within each record may include: name, password, social security number, player ID number, player address, telephone number, credit card number, hotel room number, credit balance, complimentary information, such as complimentary points awarded, a preferred payment method, payment method information, credit card number and expiration date, identification password and the amount of the wager, bank account number, and player status rating. Thus, having information related to one field, such as player ID number, allows the wagering server system manager to retrieve all information stored in the other fields of that player's record.

After the payment information has been verified, a message is sent to the player, notifying him that he is allowed to perform a slot machine gambling sequence. The notification message is sent to a related communication device. Preferably, a display device 8 is connected to the communication device 6, in order to facilitate presentation of the message.

Based upon the winnings and losses of each player, the database server of the wagering server system updates the player credit balance. Preferably, every predetermined time interval the server outputs the information regarding each player's debt or credit, allowing the operators of the wagering server system to send a debit note to the player according to his credit balance or to send him his winnings. The debt of each player may be collected from the player's credit card account or may be transferred as a debit charge in the player's cable bill, telephone bill, mobile telephone bill or Internet service provider bill.

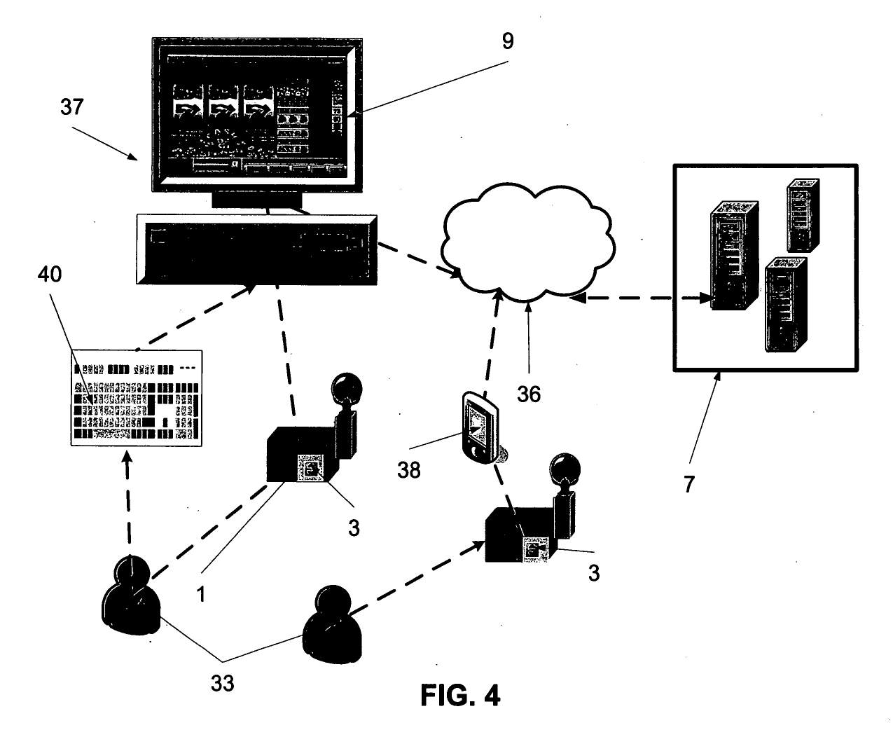

Reference is now made to FIG. 4, which shows another exemplary embodiment of the present invention. The remote slot machine controller 1, the wagering server system 7 and the visual image 9 are as shown in FIG. 3 above. In FIG. 4, however, there is depicted a computing unit 38 which may be used as the communication device, which may be a personal digital assistant (PDA) or a personal computer, which is connected to a wagering server system 7.

In another preferred embodiment of the present invention the communication interface 3 is connected to wagering server system 7 via the Internet 36. In this embodiment the communication interface 3 may be adapted to interface with a computing unit such as personal computer 37 or a personal digital assistant (PDA) 38 which is used as a communication device. Preferably the communication interface 3 comprises a conventional serial communication connection (not shown). The serial communication may include an RS-232 connection, Ethernet connection, Universal Serial Bus (USB) connection, Firewire connection, USB2 connection, Bluetooth® connection or IR connection.

Preferably, the USB or the USB2 connection can be used as a power supply, supplying electrical current to the remote slot machine controller 1.

In this preferred embodiment, players 33 can access a designated Internet gambling site, stored in a central server, using the computing unit 38, via a communication network such as the Internet. In one preferred embodiment the site is managed as HTML (Hyper Text Markup Language) files that display information forming a basis for creation of Web pages that facilitate access to the virtual slot machine.

The method of displaying the site on the basis of the HTML file is well known and hence will not be described here.

In use, a player 33 can connect the remote slot machine controller 1 to the computing unit 38, and then enter a designated Internet gambling site which simulates a slot machine gambling sequence. The website can preferably provide users with the ability to input payment information and to check gambling history and credit balance.

Preferably, the desktop keyboard 40 or the input interface of the computing unit 38 is used as a user input payment device.

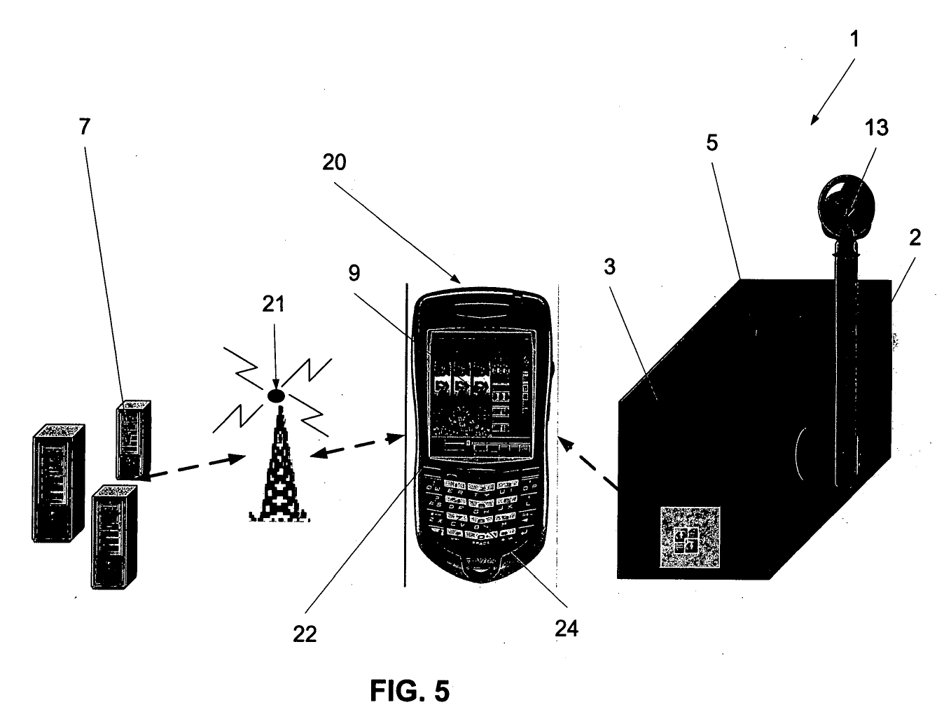

Reference is now made to FIG. 5, which shows another exemplary embodiment of the present invention. The remote slot machine controller 1, the wagering server system 7 and the visual image 9 are similar to those shown in FIG. 3 above. However this figure depicts a mobile cellular phone 20 as a communication device which is connected to a wagering server system 7.

This preferred embodiment of the present invention enables a user to participate in a slot machine sequence using his mobile phone 20. The mobile phone 20 is connected to the wagering server system 7 via a cellular network 21 in a conventional manner. As depicted above, the mobile phone functions as a communication device and interfaces between the remote slot machine controller 1 and the wagering server system 7, facilitating the transmission of gambling instructions.

In addition, the mobile phone screen display 22 may be used to display the visual images 9 which are sent from the wagering server system 7 to simulate the spinning of the slot machine's reels.

Preferably, the mobile phone keypad 24 is used as a user input payment device that allows the user to input payment information, as depicted above.

The remote slot machine controller 1 interfaces with the mobile phone 20 via the communication interface 3.

Preferably, the communication interface 3 comprises a radio frequency (RF) transmitter that communicates with an RF receiver which is integrated into the mobile phone 20. Bluetooth®, a standard for short-range digital transmission, can be used as a communication protocol for the RF communication.

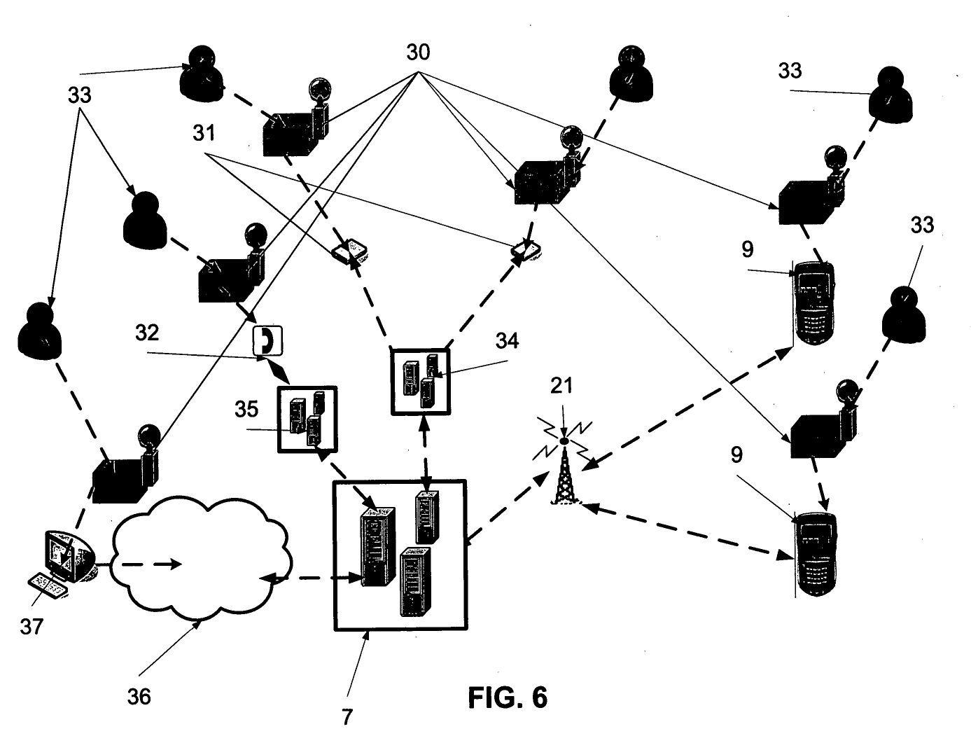

Reference is now made to FIG. 6 which shows another exemplary embodiment of the present invention. FIG. 6 depicts a distributed gambling system for facilitating the participation of remote players in a slot machine gambling sequence. The wagering server system is similar to that shown in FIG. 3 above However, this figure further depicts several remote slot machine controllers 30 and various types of communication devices 9, 31, 32.

According to this preferred embodiment of the present invention, the wagering server system 7 is designed to enable a plurality of players 33 to simultaneously participate in slot machine gambling sequences from various different locations, using different remote slot machine controllers 30. The wagering server system 7 receives gambling instructions and payment information from different players 33. The wagering system identifies each instruction received from each player according to his unique identification information as described above.

Accordingly, the Digital Video Server of the wagering server system 7 designates broadcasts of specific digital video streams that simulate a virtual slot machine for each player. Each virtual image reflects the specific player's gambling instructions, as described above. The wagering server system 7 updates each player's respective credit balance according to his winnings and losses.

Preferably, each remote slot machine controller 30 has a unique ID which is recognized by the wagering server system 7. The system can use the unique ID to track the location of different remote slot machine controllers 30. In addition, a unique password can be associated with each remote slot machine controller 30. The wagering server system can be used to match the unique ID with the unique password, thereby identifying the player and his payment information.

Preferably, the wagering server system 7 can be simultaneously connected to remote slot machine controllers 30 via different communication networks. For example, in FIG. 6 the wagering server system 7 is connected to a cable network 34, to a Public Switched Telephone Network (PSTN) 35 and to a cellular network 21 simultaneously.

Thus, the wagering server system 7 can enable players 33 to gamble via various networks by using their remote slot machine controllers 30 from various locations. Each player can either connect his remote slot machine controller 30 to the local cable network 34 during his stay at home, or can connect his remote slot machine controller 30 to a mobile phone from other locations.

In addition, since the wagering server system 7 is connected to the remote slot machine controllers 30 via communication networks, it can be positioned in any place which has a network connection. This characteristic facilitates the positioning of the wagering server system 7 in a country that allows gambling and distributing, while positioning the remote slot machine controllers in countries that prohibit the positioning of gambling servers but permits online gambling.

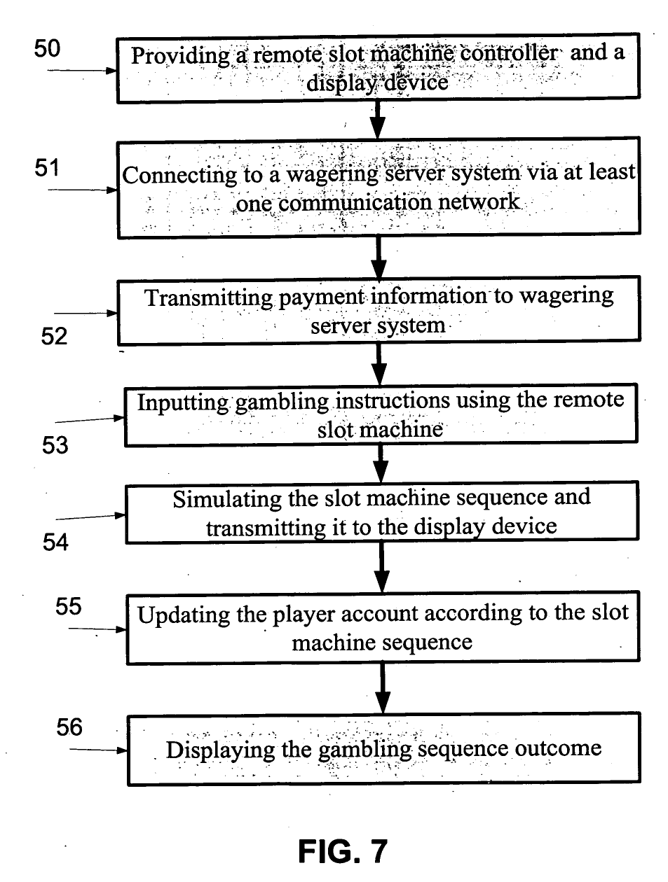

Reference is now made to FIG. 7, which is a flowchart of an exemplary method according to another preferred embodiment of the present invention. The method depicted in FIG. 7 includes remotely participating in a slot machine gambling sequence.

The first step 50 is providing a remote slot machine controller. The remote slot machine controller comprises a physical input device, a user input payment device, and a communication interface. In addition, a display device is provided. The display device is designed for generating video images of a virtual slot machine, as described above.

During the following step, 51, the communication interface of the remote slot machine controller is connected to a wagering server system via at least one communication network. This connection facilitates the next step, 52, during which the user input payment device, which is coupled to the remote slot machine controller, is used for inputting payment information to the wagering server system. The wagering server system associates the input payment information with a designated player account. In step 53, the remote slot machine controller's physical input device is used for inputting gambling instructions for initiating a slot machine gambling sequence.

In step 54 the wagering server system simulates the slot machine sequence. The slot machine sequence ends with either the player winning or losing. During step 55 the wagering server system updates the player's account in the database server. In step 56, the wagering server system transfers a visual image of the gambling sequence outcome to the player communication device. The visual image of the outcome of the slot machine sequence is displayed using a connected display device.

It is expected that during the life of this patent many relevant devices and systems will be developed and the scope of the terms herein, particularly of the terms network, communication interface, input device, display device, and force feedback mechanism, is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents, and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A remote slot machine controller apparatus for facilitating the participation of a remote user in a slot machine game sequence, said remote slot machine controller apparatus comprising:
a physical input device configured to allow a user to enter a game input during a slot machine game sequence; and
a communication interface connectable to a wagering server system via at least one communication network, said communication interface being adapted to transmit said payment information and said game input to said wagering server system.

2. The remote slot machine controller apparatus of claim 1, further comprising a user input payment device adapted to facilitate users with the ability to input payment information.

3. The remote slot machine controller apparatus of claim 1, wherein said payment information consists of at least one of the following group members: personal identification information, a password, a preferred payment method, payment method information, credit card number and expiration date, identification password and the amount of the wager, bank account number.

4. The remote slot machine controller apparatus of claim 1, wherein said physical input device comprises a handle, pivotally mounted on a housing.

5. The remote slot machine controller apparatus of claim 4, wherein pulling said handle initiates a slot machine sequence.

6. The remote slot machine controller apparatus of claim 4, wherein said physical input device further comprises a force feedback mechanism for applying force feedback to said handle.

7. The remote slot machine controller apparatus of claim 4, wherein the top end of said handle is coupled with a hand grip, wherein said hand grip being adapted to support the palm of said remote user.

8. The remote slot machine controller apparatus of claim 4, wherein said handle is positioned in an initial position; wherein said physical input device further comprises resilience to reinstate said handle to said initial position after said handle has been pulled.

9. The remote slot machine controller apparatus of claim 1, said remote slot machine controller apparatus further including a housing, wherein said physical input device is a button coupled to said housing.

10. The remote slot machine controller apparatus of claim 9, wherein said physical input device further comprises a force feedback mechanism for applying force feedback to said button.

11. The remote slot machine controller apparatus of claim 1, wherein said physical input device is coupled to a fixation component, said fixation component being adapted for attaching said physical input device to a solid surface.

12. The remote slot machine controller apparatus of claim 11, wherein said fixation component is a suction pad.

13. The remote slot machine controller apparatus of claim 11, wherein said fixation component further comprises a middle connecting component, said middle connecting component being adapted to facilitate the positioning of said physical input device at desired angle relative to said fixation component.

14. The remote slot machine controller apparatus of claim 1, wherein said communication interface is adapted to interface with one of the following communication devices: a mobile phone, a cable modem, a satellite receiver, a personal computer, a personal digital assistant (PDA) and a land line telephone.

15. The remote slot machine controller apparatus of claim 1, wherein said communication interface comprises an infrared radiation (IR) transmitter, and wherein said communication interface is adapted to interface with a communication device that comprises an IR receiver.

16. The remote slot machine controller apparatus of claim 1, wherein said communication interface comprises a radio frequency (RF) transmitter, and wherein said communication interface is adapted to interface with a communication device that comprises an RF receiver.

17. The remote slot machine controller apparatus of claim 2, where said user input payment device comprises at least one of the following interface devices: a television remote control, a desktop keyboard, laptop keyboard, a desktop mouse, a keypad, a mobile phone keypad and PDA keypad.

18. The remote slot machine controller apparatus of claim 1, further comprising a power supply for supplying electrical current to said remote slot machine controller apparatus, wherein said electrical current is either Alternating Current or Direct Current.

19. A distributed slot machine system for facilitating the participation of remote users in a slot machine game sequence, said distributed slot machine system comprising:
at least one display device being adapted for generating video images of a slot machine;
at least one remote slot machine controller associated with said display device, said remote slot machine controller comprising:
a physical input device configured to allow a user to provide a slot machine game instructions input,
a user input payment device adapted to facilitate users with the ability to input payment information, and
a communication interface connectable to a wagering server system via at least one communication network, said communication interface being adapted to transmit said payment information and said game instructions input to said wagering server system;
wherein said wagering server system is adapted for receiving said payment information and said game instructions input from said at least one remote slot machine controller, wherein said wagering server system is adapted for performing said game sequence based on said game instructions input, transmitting a game result based on a result of said game sequence and a payment made, to said display device; and wherein said wagering server system comprises a payment module for either debiting or crediting the account of a player according to said game result.

20. The distributed slot machine system of claim 19, wherein said at least one display device is chosen from the group consisting of: a television set, a video monitor, a computer screen, a mobile telephone screen and a PDA screen.

21. The distributed slot machine system of claim 19, further comprising a screen for displaying said input payment information.

22. The distributed slot machine system of claim 19, wherein said payment module is adapted to either debit or credit at least one of the following accounts according to a result of said slot machine game sequence: a credit card account, a cable account, a telephone account, a mobile phone account, and an Internet service provider account.

23. A method of participating in a slot machine game sequence, comprising:
a) providing a remote slot machine controller comprising: a physical input device, a user input payment device, and a communication interface;
b) providing a display device being adapted to generate video images of a virtual slot machine;
c) connecting said communication interface to a wagering server system via at least one communication network;
d) using said user input payment device to input payment information and associating said payment information with a player account;
e) transmitting said payment information to said wagering server system;
f) using said physical input device to input game instructions for initiating a slot machine game sequence;
g) using said wagering server system to simulate said slot machine game sequence;
h) using said display device for displaying the outcome of said slot machine game sequence; and
i) updating said player account according to an outcome of said slot machine game sequence.
